(19) United States
(12) Patent Application Publication
(10) Pub. No.: US 2017/0101049 A1
(43) Pub. Date: Apr. 13, 2017

(54) Ornate Grille Light Assembly

(71) Applicant: Billy G. Morris, Greer, SC (US)

(72) Inventor: Billy G. Morris, Greer, SC (US)

(21) Appl. No.: 14/811,766

(22) Filed: Jul. 28, 2015

(51) Int. Cl. B60Q 1/28; B60Q 1/48; B60Q 1/34; F21S 8/10

(52) U.S. Cl. CPC B60Q 1/28; F21S 48/33; F21S 48/22; F21S 48/212; B60Q 1/48; B60Q 1/34

(57) ABSTRACT

The Ornate Grille Light Assembly will use dual-filament, LED or other type lights that provide a set, or additional set, of park and turn signal lights in the grille of cars and trucks with various lens profiles; rectangular, year and trademark symbols, etc. These lens profiles will be cut out of the front bezel for illumination.

### BACKGROUND OF THE INVENTION

The Ornate Grille Light Assembly adds a park light and turn signal light to the front grill.

### BRIEF SUMMARY OF INVENTION

The Ornate Grille Light Assembly will provide better visibility to oncoming traffic and will add safety to cars that do not already have this feature.

### BRIEF DESCRIPTION OF THE MULTIPLE VIEWS ON THE DRAWINGS

FIG. 1A Depicts the front view of the light bezel with the year cut out of the light shroud.

FIG. 1B Depicts the front view of the light bezel with a bowtie cut out of the light shroud.

FIG. 1C Depicts the front view of the light bezel with a rectangle cut out of the shroud.

FIG. 1D Depicts the complete assembly with all of the parts needed to make a functioning Ornate Grille Light Assembly.

FIG. 2A Depicts a flat view of the light shroud with a bowtie cut out.

FIG. 2B Depicts forming the light shroud.

FIG. 2C Depicts the front view of the formed light shroud.

FIG. 3A Depicts the light socket pattern.

FIG. 3B Depicts the light mount plate.

FIG. 3C Depicts the side view of the light plate.

FIG. 4A Depicts the front view of the light shroud backing block.

FIG. 4B Depicts a side view of the light shroud backing block. There is not a number 5 drawing.

FIG. 5 Depicts the shroud block gasket

FIG. 6 Depicts the light shroud gasket.

FIG. 7 Depicts the light mounting plate gasket.

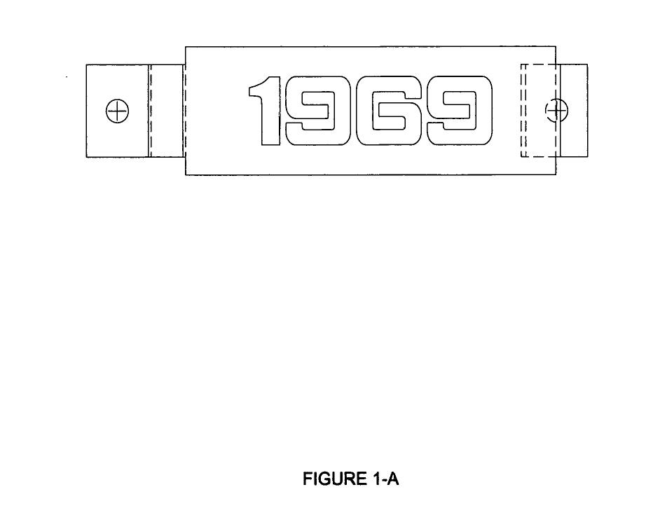

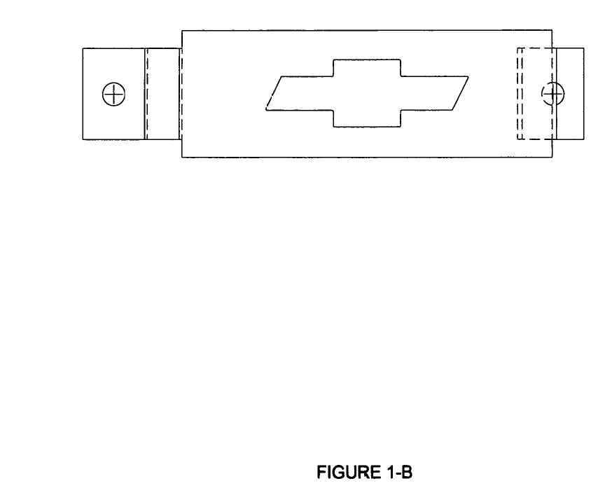

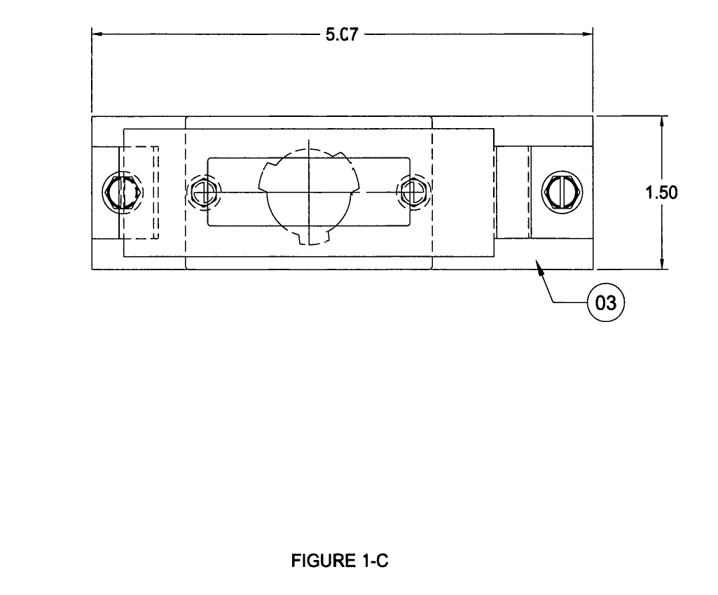

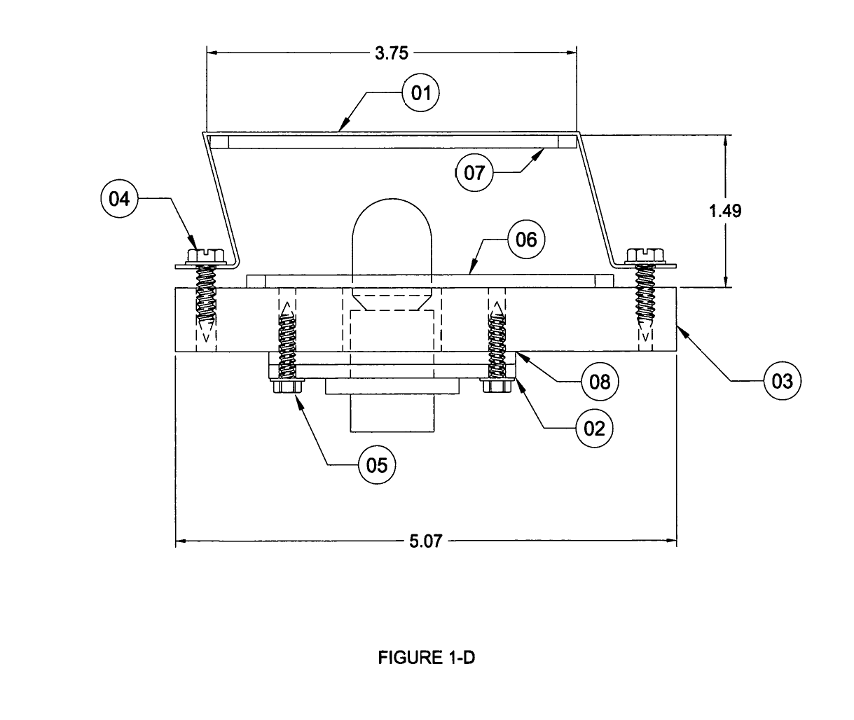

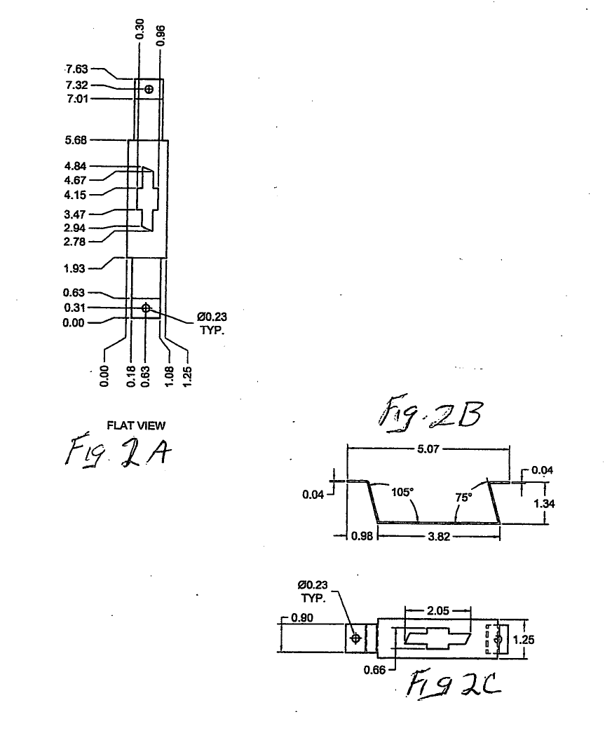

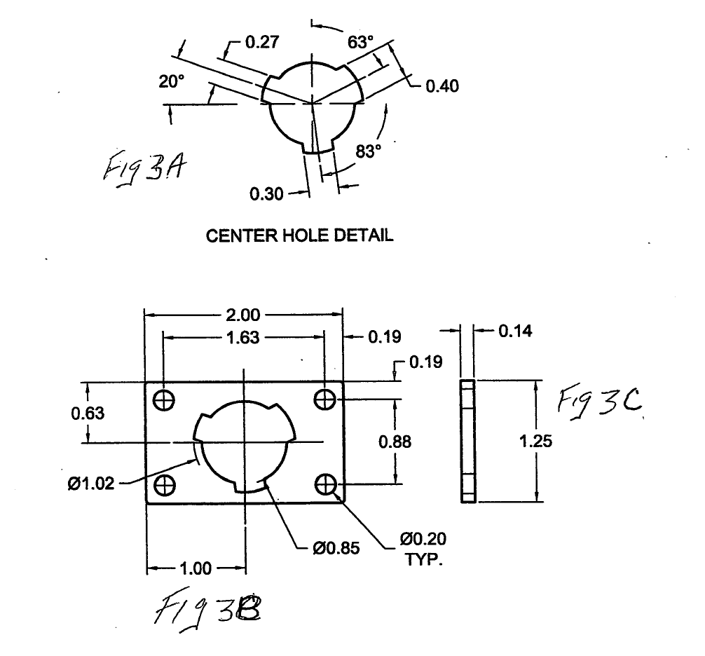

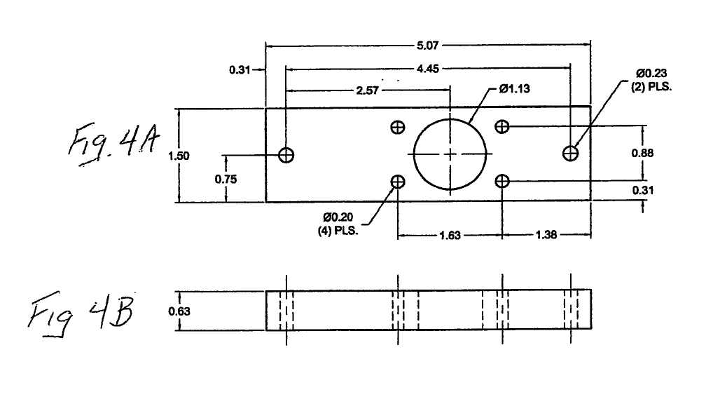

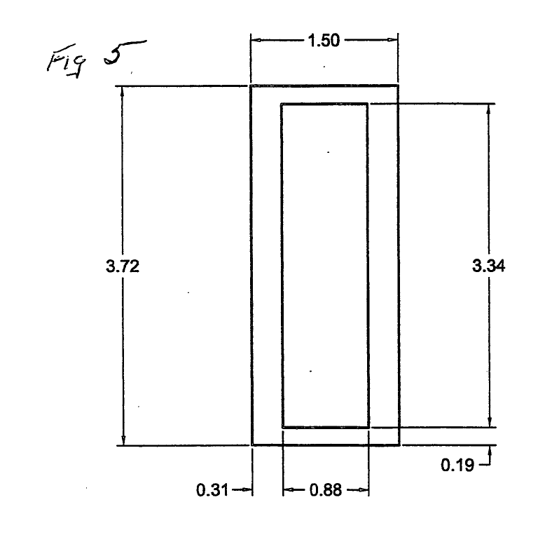

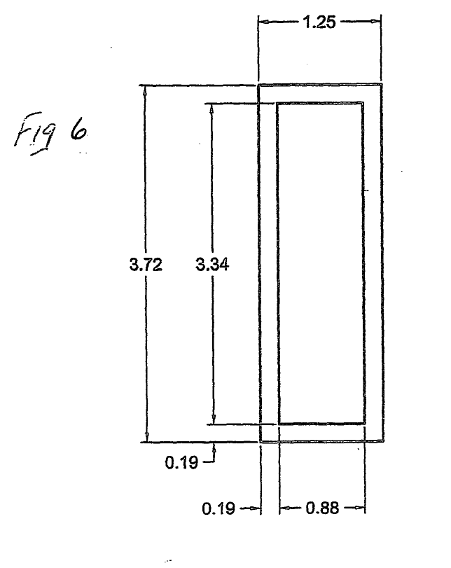

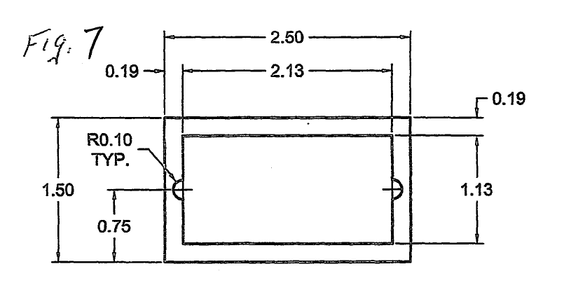

### DETAIL DESCRIPTION OF THE INVENTION

The Ornate Grille Light Assembly is a laser-cut steel bezel with different lens profiles which includes an acrylic lens and machined UHMW plastic shroud block with a stainless steel light mount plate. Neoprene gaskets make the assembly weather-proof.

1. An article of invention for an Ornate Grille Light Assembly that includes the light bezel, light source, lens, light socket assembly and weather-proofing gaskets

2. The Ornate Grille Light Assembly adds a park light and turn signal light to the front grill.
